(19) United States
(12) Patent Application Publication
(10) Pub. No.: US 2014/0371363 A1
(43) Pub. Date: Dec. 18, 2014

(54) THERMOPLASTIC RESIN COMPOSITION

(71) Applicant: Konica Minolta, Inc., Tokyo (JP)

(72) Inventors: Yuka NAKAMURA, Tokyo (JP); Ryuji KITANI, Tokyo (JP); Masashi MAMINO, Tokyo (JP); Shinichi HADEHARA, Tokyo (JP)

(21) Appl. No.: 14/296,598

(22) Filed: Jun. 5, 2014

(30) Foreign Application Priority Data
Jun. 13, 2013 (JP) 2013-124967

(51) Int. Cl. C08L 69/00

(52) U.S. Cl. CPC C08L 69/00
USPC 524/310; 524/317

(57) ABSTRACT

A thermoplastic resin composition having a high flowability during the injection molding, which suppresses generation of burning, silver and the like in a molded article, is provided as an injection molding material.

A thermoplastic resin composition containing at least a polycarbonate resin, a polyester resin, and a lubricant, wherein the lubricant contains a compound represented by the following General Formula (1) or (2) is provided.

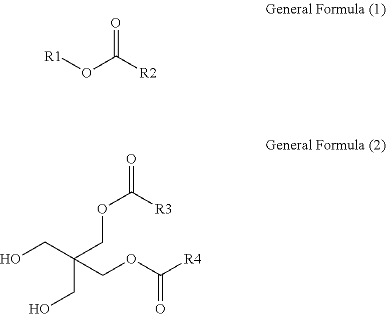

(In the General Formula (1), R1 has a structure represented by the following Chemical formula,

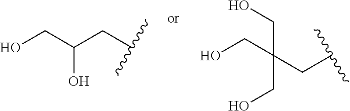

and R2 is substituted or unsubstituted alkyl group, alkenyl group, alkynyl group, cycloalkyl group, cycloalkenyl group, or cycloalkynyl group that has 11 to 40 carbon atoms, and
in the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, provided that a sum of the carbon atoms of R3 and R4 is 11 to 40.)

### CROSS-REFERENCE TO RELATED APPLICATION

This application is based on Japanese Patent Application No. 2013-124967 filed on Jun. 13, 2013, the contents of which are incorporated herein by reference.

### TECHNICAL FIELD

The present invention relates to a thermoplastic resin composition. Specifically, the present invention relates to a thermoplastic resin composition that has a high flowability suitable for injection molding, and provides an excellent appearance in a molded article.

### BACKGROUND ART

Currently, a resin such as a polycarbonate resin and a thermoplastic polyester resin, and a resin composition thereof are used in a wide range of fields as a molding material of a container, a packaging film, a household electrical appliance, an OA equipment, an AV equipment, electric or electronic parts, automobile parts or the like, from the viewpoint of excellent moldability, mechanical properties, heat resistance, weather resistance, appearance, hygiene, economic efficiency, and the like. Therefore, the used amount of such a thermoplastic resin and a molded article of the thermoplastic resin is large, and has been steadily increasing each year. Accordingly, the amount of the molded articles to be discarded as a used molded article has been also increased more and more, and thus which has become a serious social problem.

In recent years, laws such as “Law for Promotion of Sorted Collection and Recycling of Containers and Packaging (Containers and Packaging Recycling Law)”, “Law Concerning the Promotion of Eco-friendly Goods and Services by the State and Other Entities Authorities (Green Purchasing Law)”, and the like are enforced one after another, and thus interest in a material recycle technology of a molded article of such a thermoplastic resin and a resin composition thereof has been increased. In particular, establishment of a material recycle technology of PET bottles that are made from polyethylene terephthalate (hereinafter, also referred to as “PET”) resin, the used amount of which has been rapidly increased is urgently required. In addition, with the widespread use of an optical recording medium product (optical disk) such as CD, CD-R, DVD, and MD that is made from a polycarbonate resin, a method of recycling an end material discharged during the molding of such a product, and a method of recycling a polycarbonate resin that can be obtained after the removing of a reflective layer, a recording layer, and the like from an optical disk that became a waste, have been investigated.

When the resin that is obtained by the pulverization of molded products of a PET resin of a used PET bottle and the like, or a polycarbonate (hereinafter, also referred to as “PC”) resin of a used optical disk and the like, which have been withdrawn from the market, is molded again, particularly molded again by an injection molding method, in order to apply to various molded articles, high flowability during the molding is required as the property of the resin. In addition, a resin composition in which the generation of foreign matters such as black lines (burning) generated in a molded article by thermal decomposition of the molding material or by burnt due to the residual air, and silver-white streaks (silver) generated in the direction of flow of the material on the surface or inside of a molded article is suppressed during the molding, and the moldability is improved is required.

In order to improve the flowability of resin in the molding process, and to suppress the generation of foreign matters, for example, Patent Literature 1, discloses a method of reducing the adhesion of resin to a metal by using an ester of dipentaerythritol and a saturated aliphatic carboxylic acid having 13 to 35 carbon atoms in a thermoplastic resin composition.

### CITATION LIST

### Patent Literature

[Patent Literature 1] JP-A-2012-136558

### SUMMARY OF INVENTION

### Technical Problem

However, a thermoplastic resin composition in which the flowability is higher and the moldability is improved is required.

The present invention has been made in consideration of the circumstances described above, and an object of the present invention is to provide as an injection molding material a thermoplastic resin composition having a high flowability during the injection molding, which suppresses the generation of burning, silver and the like in the molded article.

### Solution to Problem

The present inventors have conducted intensive studies in order to solve the problem described above. As a result, in a thermoplastic resin composition containing a polycarbonate resin, a polyester resin, and a lubricant, it was found that the problem described above is solved by using a specific compound as the lubricant, and thus the present invention has been completed.

That is, the present invention is achieved by a thermoplastic resin composition having the following constitution.

1. A thermoplastic resin composition containing at least a polycarbonate resin, a polyester resin, and a lubricant, in which the lubricant contains a compound represented by the following General Formula (1) or (2).

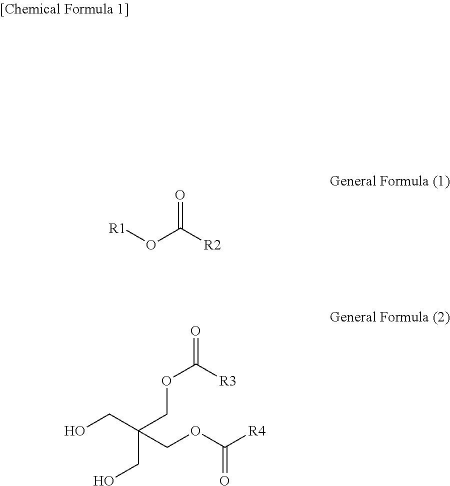

(In the General Formula (1), R1 has a structure represented by the following Chemical formula,

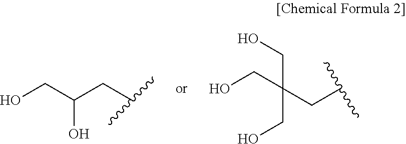

and R2 is substituted or unsubstituted alkyl group, alkenyl group, alkynyl group, cycloalkyl group, cycloalkenyl group, or cycloalkynyl group that has 11 to 40 carbon atoms, and

in the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, provided that a sum of the number of the carbon atoms of R3 and R4 is 11 to 40.)

2. The thermoplastic resin composition described in the above 1, in which the lubricant is contained in an amount of 0.01 to 5 parts by mass relative to 100 parts by mass of the total mass of the polycarbonate resin and the polyester resin.

3. The thermoplastic resin composition described in the above 1, wherein the polycarbonate resin is mixed with the polyester resin at a mixing ratio of 70 to 2 parts by mass of the polyester resin relative to 30 to 98 parts by mass of the polycarbonate resin.

4. The thermoplastic resin composition described in the above 1, in which the content of a compound represented by the above General Formula (1) or (2) in the lubricants is at least 80% by mass or more.

5. The thermoplastic resin composition described in the above 1, in which the number of the carbon atoms of the R2 in the General Formula (1) is in the range of 13 to 35.

6. The thermoplastic resin composition described in the above 1, in which the sum of the number of the carbon atoms of R3 and R4 in the General Formula (2) is in the range of 13 to 35.

7. The thermoplastic resin composition described in the above 1, in which resin materials selected from one or more kinds of polyolefins, polyamides, elastomers, and ABS resins are contained in an amount of 0.1 to 20% by mass relative to 100% by mass of the total mass of the polycarbonate resin and the polyester resin.

8. The thermoplastic resin composition described in the above 1, in which additives selected from one or more kinds of a crosslinking agent, an antioxidant, a thermal stabilizer, a transesterification inhibitor, an ultraviolet absorbing agent, alight stabilizer, a pigment, a dye, a flame retardant, an antistatic agent, a foaming agent, a drip preventing agent, and a filler are contained in an amount of 0.01 to 10% by mass relative to 100% by mass of the total mass of the polycarbonate resin and the polyester resin.

### DESCRIPTION OF EMBODIMENTS

Hereinafter, embodiments of the present invention will be explained.

According to one embodiment of the present invention, a thermoplastic resin composition containing at least a polycarbonate resin, a polyester resin, and a lubricant, in which the lubricant contains a compound represented by the following General Formula (1) or (2), is provided.

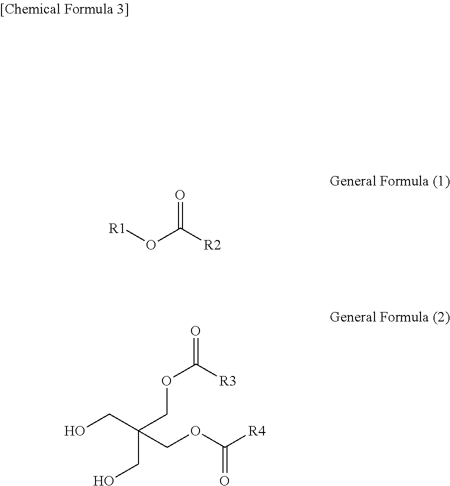

(In General Formula (1), R1 has a structure represented by the following Chemical formula,

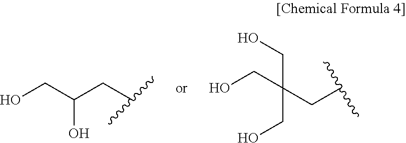

and R2 is substituted or unsubstituted alkyl group, alkenyl group, alkynyl group, cycloalkyl group, cycloalkenyl group, or cycloalkynyl group that has 11 to 40 carbon atoms.

In the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, provided that a sum of the number of the carbon atoms of R3 and R4 is 11 to 40.

According to the present invention, by using a specific lubricant in a thermoplastic resin composition containing a polycarbonate resin and a polyester resin, the flowability of thermoplastic resin composition during the injection molding can be improved. In addition, the generation of burning and silver is suppressed in a molded article, and a molded article having an excellent appearance can be provided.

Hereinafter, the present invention will be explained in detail.

### (Polycarbonate Resin)

A polycarbonate resin can be an aromatic homopolycarbonate resin or aromatic copolycarbonate resin that can be obtained by the reaction of an aromatic dihydric phenol-based compound and phosgene or a carbonic acid diester. As a production method of such a polycarbonate resin, the production method is not particularly limited, but a known method may be employed. Examples of the production method of a polycarbonate resin include, for example, a method comprising directly reacting phosgene and the like with an aromatic dihydric phenol-based compound (an interfacial polymerization method), and a method comprising performing an ester exchange reaction of an aromatic dihydric phenol-based compound and a carbonic acid diester such as diphenyl carbonate in a molten state (a solution method).

A viscosity average molecular weight of an aromatic homopolycarbonate resin or aromatic copolycarbonate resin is preferably in the range of 1×10⁴ to 1×10⁶. The viscosity average molecular weight of a polycarbonate resin is measured by using “CBM-20A lite system” and “GPC software” (these are manufactured by Shimadzu Corporation).

Examples of the aromatic dihydric phenol-based compound include 2,2-bis(4-hydroxyphenyl) propane,
2,2-bis(4-hydroxy-3,5-dimethylphenyl)propane,
bis(4-hydroxyphenyl)methane,
1,1-bis(4-hydroxyphenyl)ethane,
2,2-bis(4-hydroxyphenyl)butane,
2,2-bis(4-hydroxy-3,5-diphenyl)butane,
2,2-bis(4-hydroxy-3,5-diethylphenyl)propane,
2,2-bis(4-hydroxy-3,5-diethylphenyl)propane,
1,1-bis(4-hydroxyphenyl)cyclohexane, and
   1-phenyl-1,1-bis(4-hydroxyphenyl)ethane, and these can be used alone or as a mixture thereof.

As the carbonic acid diester, for example, diaryl carbonate such as diphenyl carbonate, di-tolyl carbonate, and bis(chlorophenyl)carbonate; dialkyl carbonate such as dimethyl carbonate, and diethyl carbonate; carbonyl halide such as phosgene; haloformate such as dihydric phenol dihaloformate, and the like can be used, but the carbonic acid diester is not limited thereto. Among them, diphenyl carbonate is preferable. These carbonic acid diesters may also be used alone or in combination of two or more kinds thereof.

The polycarbonate resin may be, for example, a branched polycarbonate resin obtained by copolymerizing a polyfunctional aromatic compound with 3 or more functional groups such as 1,1,1-tris(4-hydroxyphenyl)ethane, or 1,1,1-tris(3,5-dimethyl-4-hydroxyphenyl)ethane; or may also be a polyester carbonate resin obtained by copolymerizing aromatic or aliphatic bifunctional carboxylic acid. Further, the polycarbonate resin may be a mixture obtained by mixing two or more kinds of the obtained polycarbonate resins.

In addition, the polycarbonate resin may be a polycarbonate resin obtained from a molded product that is discarded as a used molded product (a recycled polycarbonate resin).

The content of polycarbonate resin in the resin composition of the present invention is not particularly limited, but is preferably 30 to 98% by mass, more preferably 40 to 98% by mass, and still more preferably 40 to 95% by mass relative to the total mass of the polycarbonate resin and the polyester resin.

### (Polyester Resin)

The polyester resin is not particularly limited, but is preferably aromatic polyester having a structure in which an aromatic dicarboxylic acid or an ester derivative component thereof is coupled with a diol component such as aliphatic diol and alicyclic diol by an ester reaction. As the polyester resin, for example, a resin obtained by the polycondensation of an aromatic dicarboxylic acid or an ester derivative component thereof and aliphatic diol, alicyclic diol or the like by a known method may be used.

Examples of the aromatic dicarboxylic acid are not particularly limited, but include terephthalic acid, isophthalic acid, orthophthalic acid, 1,5-naphthalene dicarboxylic acid, 2,5-naphthalene dicarboxylic acid, 2,6-naphthalene dicarboxylic acid, 2,2′-biphenyl dicarboxylic acid, 3,3′-biphenyl dicarboxylic acid, 4,4′-biphenyl dicarboxylic acid, 4,4′-diphenyl ether dicarboxylic acid, 4,4′-diphenylmethane dicarboxylic acid, 4,4′-diphenylsulfone dicarboxylic acid, 4,4′-diphenyl isopropylidene dicarboxylic acid, 1,2-bis(phenoxy)ethane-4,4′-dicarboxylic acid, 2,5-anthracene dicarboxylic acid, 2,6-anthracene dicarboxylic acid, 4,4′-p-terphenylene dicarboxylic acid, and 2,5-pyridine dicarboxylic acid.

Examples of the aliphatic diol include ethylene glycol, propylene glycol, butylene glycol, hexylene glycol, neopentyl glycol, 2-methyl-1,3-propanediol, diethylene glycol, and triethylene glycol. Examples of the alicyclic diol include 1,4-cyclohexane dimethanol.

In both of the aromatic dicarboxylic acid and the aliphatic diol or the alicyclic diol, each of the compounds described above may be used alone or in combination of two or more kinds thereof. Further, the polyester resin constituting the resin composition of the present invention may have 1 mol % or less of a structural component derived from a monomer with 3 or more functional groups such as glycerol, trimethylolpropane, pentaerythritol, trimellitic acid, and pyromellitic acid, based on the total structural units.

Specifically, examples of the polyester resin include polyethylene terephthalate, polypropylene terephthalate, polybutylene terephthalate, polyethylene naphthalate, polybutylene naphthalate, and polyethylene-1,2-bis(phenoxy)ethane-4,4′-dicarboxylate; and copolyesters such as polyethylene isophthalate/terephthalate, polybutylene terephthalate/isophthalate, polybutylene terephthalate/decane dicarboxylate, and the like. Among them, from the viewpoint of the compatibility, polyethylene terephthalate or polybutylene terephthalate is particularly preferable.

Further, the polyester resin may be recovered polyester (a recycled material). Examples of the recovered polyester include a recycled material of a polyethylene terephthalate bottle (a PET bottle), and a polyethylene terephthalate film (a PET film).

The polyester resin is preferably a polyester resin having an intrinsic viscosity that is measured at a temperature of 25° C. in a 0.5% o-chlorophenol solution, of 0.70 to 1.9, and particularly 1.0 to 1.7. In the case where the intrinsic viscosity is in this range, a thermoplastic resin composition in which the moldability and the property balance are particularly excellent can be obtained.

The content of the polyester resin in the resin composition of the present invention is not particularly limited, but is preferably 2 to 70% by mass, more preferably 2 to 60% by mass, and still more preferably 5 to 60% by mass, relative to the total mass of the polycarbonate resin and the polyester resin.

### (Lubricant)

The resin composition of the present invention contains a compound represented by the following General Formula (1) or (2) as a lubricant.

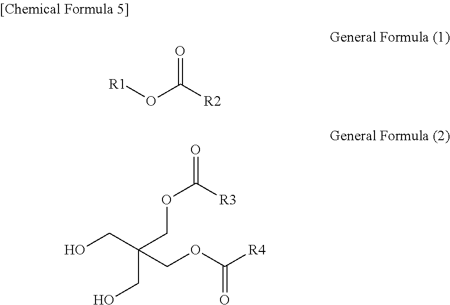

(In the General Formula (1), R1 has a structure represented by the following Chemical formula,

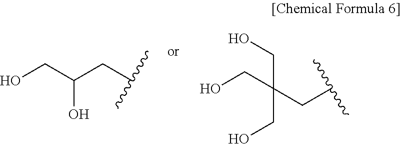

and R2 is substituted or unsubstituted alkyl group, alkenyl group, alkynyl group, cycloalkyl group, cycloalkenyl group, or cycloalkynyl group that has 11 to 40 carbon atoms.

In the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, provided that the sum of the number of the carbon atoms of R3 and R4 is 11 to 40.

The compound represented by the above General Formula (1) or (2) can act as a lubricant in the thermoplastic resin composition containing the polycarbonate resin and the polyester resin.

The compound represented by the above General Formula (1) or (2) has an SP value close to the SP value of the polycarbonate resin. Therefore, the lubricant and the resin are easily settled to each other, and thus the lubricant is homogeneously dispersed in the resin composition. As a result, a resin composition having a high flowability can be obtained. In addition, because the flowability of the resin composition is sufficiently high, discoloration or black lines (also referred to as burning) generated in a molded article as a result of the thermal decomposition of a resin composition during the injection molding, or of the burnt of the resin composition due to the residual air can be suppressed. Further, the flowability of the resin composition is sufficiently high, and thus silver-white streaks (also referred to as silver) generated in the direction of flow of the material on a surface or inside of the molded article can be suppressed. As a result, a thermoplastic resin composition which shows an improved moldability, and provides a molded article having an excellent appearance, can be obtained.

Herein, an SP value is a solubility parameter δ at 25° C., and a value specific to a compound, which is calculated from δ=(ΔE/V)^{1/2}, using an evaporation energy ΔE and a molar volume V of each compound. The SP value is one of the measures to predict the solubility of a compound. It indicates that the larger the SP value is, the higher the polarity is, and the smaller the SP value is, the lower the polarity is. Further, in the case where two compounds are mixed, the smaller the difference between the SP values of the two compounds is, the higher the compatibility is.

In the lubricant used for the thermoplastic resin composition of the present invention, the content of the compound represented by the above General Formula (1) or (2) is preferably at least 80% by mass or more, more preferably 90% by mass or more, and still more preferably 100% by mass. The upper limit value of the content of the compound represented by the above General Formula (1) or (2) is 100% by mass. A lubricant other than the compound represented by the above General Formula (1) or (2) is not particularly limited, but a conventionally known lubricant can be used as the lubricant.

The production method of the compound represented by the above General Formula (1) or (2) is not particularly limited. For example, the compound can be produced by a conventionally known method using a polyol compound and a carboxylic acid compound as the raw material. For example, the compound represented by the General Formula (1) can be produced by performing a condensation reaction of R1OH and R2COOH. For example, the compound represented by the General Formula (2) can be produced by a conventionally known method using C (CH₂OH)₄, R3COOH, and R4COOH as the raw material.

In this case, each of R2, R3 and R4 in the carboxylic acid compounds (R2COOH, R3COOH, and R4COOH) corresponds to each of R2, R3 and R4 in the General Formula (1) or (2). These carboxylic acid compounds may be the compounds that can produce the compound of the General Formula (1) or (2). Examples of the carboxylic acid compound include, for example, formic acid, pentanoic acid, heptanoic acid, decanoic acid, undecanoic acid, dodecanoic acid, tridecanoic acid, tetradecanoic acid, pentadecanoic acid, hexadecanoic acid, heptadecanoic acid, octadecanoic acid (stearic acid), nonadecanoic acid, erucic acid, and montanic acid.

Examples of a reaction catalyst include, for example, sodium hydroxide, potassium hydroxide, barium hydroxide, calcium hydroxide, calcium oxide, barium oxide, magnesium oxide, zinc oxide, sodium carbonate, potassium carbonate, and an organotin compound such as 2-ethylhexyl tin.

Further, as the compound represented by the General Formula (1) or (2), a compound available on the market may be used.

In the General Formula (1), R2 is substituted or unsubstituted alkyl group, alkenyl group, alkynyl group, cycloalkyl group, cycloalkenyl group, or cycloalkynyl group that has 11 to 40 carbon atoms. In the case where the number of the carbon atoms of R2 is higher than 40, the SP value of the lubricant becomes smaller and is away from the SP value of the resin, and thus the lubricant is hardly homogeneously dispersed in the resin. As a result, the distribution of the lubricant in the thermoplastic resin composition has a deviation, and the flowability is not sufficiently improved. In the case where the number of the carbon atoms of R2 is lower than 11, the molecular weight of the lubricant becomes smaller, and low molecular weight components increase in the thermoplastic resin composition, and thus the strength is lowered. In the General Formula (1), the number of the carbon atoms of R2 is at least in the range of 11 to 40, and the number of the carbon atoms of R2 is preferably in the range of 13 to 35.

R2 is preferably substituted or unsubstituted alkyl group or alkenyl group that has 11 to 40 carbon atoms, and more preferably a substituted or unsubstituted alkyl group having 11 to 40 carbon atoms. In the case where R2 is alkyl group or alkenyl group, the SP value of the lubricant becomes closer to the SP value of the resin, and thus the dispersibility of the lubricant is improved, and the flowability of the resin can be improved.

In the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, and the sum of the number of the carbon atoms of R3 and R4 is in the range of 11 to 40.

In the case where the sum of the number of the carbon atoms of R3 and R4 is higher than 40, the SP value of the lubricant becomes smaller and is away from the SP value of the resin, and thus the lubricant is hardly homogeneously dispersed in the resin. As a result, the distribution of the lubricant in the thermoplastic resin composition has a deviation, and the flowability is not sufficiently improved. Further, in the case where the sum of the number of the carbon atoms of R3 and R4 is lower than 11, the molecular weight of the lubricant becomes smaller, and low molecular weight components increase in the thermoplastic resin composition, and thus the strength is lowered. Preferably, the sum of the number of the carbon atoms of R3 and R4 is in the range of 13 to 35.

In addition, each of R3 and R4 is preferably a hydrogen atom, or substituted or unsubstituted alkyl group or alkenyl group that has 1 to 40 carbon atoms, and more preferably a substituted or unsubstituted alkyl group having 1 to 40 carbon atoms. In the case where each of R3 and R4 is alkyl group or alkenyl group, the SP value of the lubricant becomes closer to the SP value of the resin, and thus the dispersibility of the lubricant is improved, and the flowability of the resin can be improved.

Herein, the alkyl group is selected from the alkyl groups that have the number of the carbon atoms or sum of the number of the carbon atoms described above. Examples of the alkyl group include, methyl group, ethyl group, n-propyl group, isopropyl group, n-butyl group, isobutyl group, sec-butyl group, tert-butyl group, n-pentyl group, isopentyl group, tert-pentyl group, neopentyl group, 1,2-dimethyl propyl group, n-hexyl group, isohexyl group, 1,3-dimethyl butyl group, 1-isopropyl propyl group, 1,2-dimethyl butyl group, n-heptyl group, 1,4-dimethyl pentyl group, 3-ethylpentyl group, 2-methyl-1-isopropyl propyl group, 1-ethyl-3-methylbutyl group, n-octyl group, 2-ethylhexyl group, 3-methyl-1-isopropylbutyl group, 2-methyl-1-isopropyl group, 1-t-butyl-2-methylpropyl group, n-nonyl group, 3,5,5-trimethylhexyl group, n-decyl group, isodecyl group, n-undecyl group, 1-methyldecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, n-heneicosyl group, n-docosyl group, n-tricosyl group, n-tetracosyl group, n-pentacosyl group, n-hexacosyl group, n-heptacosyl group, n-octacosyl group, n-triacontyl group, n-hentriacontyl group, n-dotriacontyl group, n-tritriacontyl group, n-tetratriacontyl group, and n-pentatriacontyl group.

The alkenyl group is not particularly limited as long as the alkenyl group is an alkenyl group having the number of the carbon atoms or sum of the number of the carbon atoms described above. Examples of the alkenyl group include vinyl group, allyl group, 2-butenyl group, 3-pentenyl group, hexenyl group, heptenyl group, octenyl group, nonenyl group, decenyl group, and heneicoseneyl group.

The alkynyl group is not particularly limited as long as the alkynyl group is an alkynyl group having the number of the carbon atoms or sum of the number of the carbon atoms described above. Examples of the alkynyl group include 2-butynyl group, 3-pentynyl group, hexynyl group, heptynyl group, octynyl group, decynyl group, and dodecynyl group.

The cycloalkyl group is not particularly limited as long as the cycloalkyl group is a cycloalkyl group having the number of the carbon atoms or sum of the number of the carbon atoms described above. Examples of the cycloalkyl group include cyclopropyl group, cyclobutyl group, cyclopentyl group, cyclohexyl group, cycloheptyl group, cyclooctyl group, cyclodecyl group, and cyclododecyl group.

The cycloalkenyl group is not particularly limited as long as the cycloalkenyl group is a cycloalkenyl group having the number of the carbon atoms or sum of the number of the carbon atoms described above. Examples of the cycloalkenyl group include cyclopropenyl group, cyclobutenyl group, cyclopentenyl group, cyclohexenyl group, cycloheptenyl group, cyclooctenyl group, cyclodecenyl group, and cyclododecenyl group.

The cycloalkynyl group is not particularly limited as long as the cycloalkynyl group is a cycloalkynyl group having the number of the carbon atoms or sum of the number of the carbon atoms described above. Examples of the cycloalkynyl group include cyclobutynyl group, cyclopentynyl group, cyclohexynyl group, cycloheptynyl group, cyclooctynyl group, cyclodecynyl group, and cyclododecynyl group.

Examples of the substituent include nitro group, amino group, hydroxy group, and cyano group, but the substituent is not limited thereto.

As a compound represented by the above General Formula (1), C₁₁H₂₃COOCH₂CHOHCH₂OH, C₁₇H₃₅COOCH₂CHOHCH₂OH, C₁₈H₃₇COOCH₂CHOHCH₂OH, C₂₇H₅₅COOCH₂CHOHCH₂OH, CH₃(CH₂)₇CH═CH(CH₂)₁₁COOCH₂CHOHCH₂OH, C₁₁H₂₃COOCH₂C(CH₂OH)₃, C₁₇H₃₅COOCH₂C(CH₂OH)₃, C₁₈H₃₇COOCH₂C(CH₂OH)₃, C₂₇H₅₅COOCH₂C(CH₂OH)₃, CH₃(CH₂)₇CH═CH(CH₂)₁₁COOCH₂C(CH₂OH)₃, and the like can be preferably used. In these compounds, the dispersibility is high in a resin including a polycarbonate resin, the high flowability is provided in a resin composition, and the effect of the suppressing of the generation of burning and silver in a molded article is high.

In the same way, as a compound represented by the above General Formula (2), (C₆H₁₃COOCH₂)₂C(CH₂OH)₂, (C₁₁H₂₃COOCH₂)₂C(CH₂OH)₂, (C₁₅H₃₁COOCH₂)₂C(CH₂OH)₂, (C₁₇H₃₅COOCH₂)₂C(CH₂OH)₂, (C₁₈H₃₇COOCH₂)₂C(CH₂OH)₂, (CH₃COOCH₂)(C₁₁H₂₃COOCH₂)C(CH₂OH)₂, (CH₃COOCH₂)(C₁₅H₃₁COOCH₂)C(CH₂OH)₂, (CH₃COOCH₂)(C₁₇H₃₅COOCH₂)C(CH₂OH)₂, (CH₃COOCH₂)(C₁₈H₃₇COOCH₂)C(CH₂OH)₂, (CH₃COOCH₂)(CH₃(CH₂)₇CH═CH(CH₂)₁₁COOCH₂)C(CH₂OH)₂, (C₆H₁₃COOCH₂)(C₁₁H₂₃COOCH₂)C(CH₂OH)₂, (C₆H₁₃COOCH₂)(C₁₅H₃₁COOCH₂)C(CH₂OH)₂, (C₆H₁₃COOCH₂)(C₁₇H₃₅COOCH₂)C(CH₂OH)₂, (C₆H₁₃COOCH₂)(C₁₈H₃₇COOCH₂)C(CH₂OH)₂, (C₆H₁₃COOCH₂)(CH₃ (CH₂)₇CH═CH(CH₂)₁₁COOCH₂)C(CH₂OH)₂, (C₁₁H₂₃COOCH₂)(C₁₅H₃₁COOCH₂)C(CH₂OH)₂, (C₆H₁₃COOCH₂)(C₁₇H₃₅COOCH₂)C(CH₂OH)₂, (C₆H₁₃COOCH₂)(C₁₈H₃₇COOCH₂)C(CH₂OH)₂, (C₆H₁₃COOCH₂)(CH₃ (CH₂)₇CH═CH(CH₂)₁₁COOCH₂)C(CH₂OH)₂, (C₁₅H₃₁COOCH₂)(C₁₇H₃₅COOCH₂)C(CH₂OH)₂, (C₁₅H₃₁COOCH₂)(C₁₈H₃₇COOCH₂)C(CH₂OH)₂, (C₁₅H₃₁COOCH₂)(CH₃ (CH₂)₇CH═CH(CH₂)₁₁COOCH₂)C(CH₂OH)₂, (C₁₇H₃₅COOCH₂)(C₁₈H₃₇COOCH₂)C(CH₂OH)₂, (C₁₇H₃₅COOCH₂)(CH₃ (CH₂)₇CH═CH(CH₂)₁₁COOCH₂)C(CH₂OH)₂, (C₁₈H₃₇COOCH₂)(CH₃ (CH₂)₇CH═CH(CH₂)₁₁COOCH₂)C(CH₂OH)₂, and the like can be preferably used.

The content of the lubricant in the thermoplastic resin composition is not particularly limited, but is preferably 0.01 to 5 parts by mass, and more preferably 0.05 to 4.5 parts by mass relative to 100 parts by mass of the total mass of the polycarbonate resin and the polyester resin. In the case where the content of the lubricant is 0.01 part by mass or more relative to 100 parts by mass of the total mass of the polycarbonate resin and the polyester resin, the effect of the improvement of the flowability of the thermoplastic resin composition is large. Further, in the case where the content of the lubricant is 5 parts by mass or less, sufficient impact strength can be obtained.

### (Other Resin Components)

Into the thermoplastic resin composition of the present invention, in addition to the polycarbonate resin, the polyester resin, and the lubricant described above, other resin components (resin materials), and arbitrarily additives (optional components) as needed may be mixed as long as the object of the present invention is achieved. By the addition of, for example, polyolefins such as polyethylene, and polypropylene; polyamides such as nylon 6, and nylon 66; various elastomers; ABS resins, and the like as other resin components (resin materials), the performance as the resin for molding can be improved.

Further, examples of the optional components (additives) include, a crosslinking agent (for example, a phenol resin), an antioxidant (a hindered phenol-based, a sulfur-containing organic compound-based, a phosphorus-containing organic compound-based, and the like), a thermal stabilizer (a phenol-based, an acrylate-based, and the like), an transesterification inhibitor (a mixture of monostearyl acid phosphate and distearyl acid phosphate, and the like), an ultraviolet absorbing agent (a benzotriazole-based, a benzophenone-based, a salicylate-based, and the like), a light stabilizer (an organic nickel-based, a hindered amine-based, and the like), a lubricant other than the above (metal salts of higher fatty acid, higher fatty acid amides, and the like), a plasticizer (phthalic acid esters, phosphoric acid esters, and the like), a pigment (carbon black, titanium oxide) or dye, a flame retardant, an antistatic agent, a foaming agent, and a drip preventing agent (for example, polytetrafluoroethylene (PTFE)).

Further, another example of the optional components include filler such as a metal fiber, an aramid fiber, asbestos, a potassium titanate whisker, wollastonite, a glass flake, a glass bead, talc, mica, clay, calcium carbonate, barium sulfate, titanium oxide, aluminum oxide, or the like. Among them, a glass fiber, a carbon fiber, and a metal fiber are preferable, and a carbon fiber is the most preferable. The kind of these fibrous fillers is not particularly limited as long as the fibrous filler is used in general for the reinforcement of the resin, and the fibrous filler can be used by the selection from, for example, a chopped strand of a long fiber type or short fiber type, a milled fiber, and the like.

The content of other resin components is preferably 0.1 to 20% by mass, and more preferably 1 to 10% by mass relative to 100% by mass of the total mass of the polycarbonate resin and the polyester resin. Specifically, one or more kinds of resin materials selected from polyolefins, polyamides, various elastomers, and ABS resins are contained in an amount of preferably 0.1 to 20% by mass, and more preferably 1 to 10% by mass relative to 100% by mass of the total mass of the polycarbonate resin and the polyester resin. In addition, the content of optional components is preferably 0.01 to 10% by mass, and more preferably 0.1 to 5% by mass relative to 100% by mass of the total mass of the polycarbonate resin and the polyester resin. For example, one or more kinds of additives selected from a crosslinking agent, an antioxidant, a thermal stabilizer, a transesterification inhibitor, an ultraviolet absorbing agent, a light stabilizer, a pigment, a dye, a flame retardant, an antistatic agent, a foaming agent, a drip preventing agent, and a filler are contained in an amount of preferably 0.01 to 10% by mass, and more preferably 0.1 to 5% by mass relative to 100% by mass of the total mass of the polycarbonate resin and the polyester resin.

### (Production Method of Thermoplastic Resin Composition)

A production method of the thermoplastic resin composition of the present invention is not particularly limited. For example, by the melt-kneading of the mixture comprising at least a polycarbonate resin, a polyester resin, and a lubricant containing a compound represented by the above-described General Formula (1) or (2), a thermoplastic resin composition can be obtained. At this time, before the melt-kneading, the preliminary mixing in which each component is mixed in advance may be performed. Further, after the preliminary mixing, before the melt-kneading, in order to suppress the hydrolysis reaction of the polyester resin, the mixture is preferably dried. In addition, a polycarbonate resin and a polyester resin are preliminary mixed and vacuum dried in advance by a dry blend or the like, and a lubricant is added and mixed in the dried mixture, then the resultant mixture may be melt-kneaded.

The melt-kneading can be performed by a Bunbury mixer, a roll, a single- or multi-screw extruder, or the like, and preferably performed by a twin-screw extruder. The melt-kneading conditions are not particularly limited, but for example, the melt-kneading temperature is preferably in the range of 240 to 300° C., and more preferably in the range of 250 to 280° C. The kneading pressure is not particularly limited, but preferably 1 to 20 MPa.

Preferably, the polycarbonate resin is mixed with the polyester resin at a mixing ratio of 70 to 2 parts by mass of the polyester resin relative to 30 to 98 parts by mass of the polycarbonate resin. In addition, the lubricant is preferably used in an amount of 0.001 to 5 parts by mass relative to the total mass of the polycarbonate resin and the polyester resin.

The kneaded polymer mixture in a molten state, which is obtained by the melt-kneading as described above, is preferably injected, and then subjected to the cooling treatment. The cooling treatment is not particularly limited, but for example, a method of water cooling the above-described kneaded polymer mixture by the immersion into water at 0 to 60° C., a method of cooling the kneaded polymer mixture by a gas at −40 to 60° C., a method of bringing the kneaded polymer mixture into contact with metal at −40 to 60° C., and the like can be used for the cooling treatment.

The resin composition obtained in this way is, for example, preferably cut by a pelletizer, and pelletized, in order to facilitate the process during the injection molding according to an injection molding method.

### (Resin Molded Article)

The thermoplastic resin composition of the present invention can be molded into a resin molded article by an arbitrarily technique. Examples of the technique for the molding include injection molding, extrusion molding, blow molding, vacuum molding, profile extrusion molding, compression molding, and gas assist molding.

The resin molded article of the thermoplastic resin composition of the present invention can be used for electric or electronic parts, automobile parts, machine mechanism parts, housing parts of an OA equipment or household electrical appliance, and the like. In particular, the resin molded article is preferably used for a housing of an OA equipment such as a printer.

### EXAMPLES

The effect of the present invention will be explained by using the following Examples and Comparative examples. However, the technical scope of the present invention is not limited thereto.

The polycarbonate resin and polyester resin used in Examples are indicated below.

Polycarbonate resin: TARFLON A-1900 (Idemitsu Kosan Co., Ltd.)

Polyester resin: polyethylene terephthalate resin (DIANITE MA521H-D25 (Mitsubishi Rayon Textile Co., Ltd.)

Lubricant: exemplary compounds 1 to 8, and comparative compounds 1 to 8 (Table 1)

### [Lubricant: Manufacturing Method of Each Exemplary Compound]

Exemplary compound 1: 1 mole of glycerol, 1 mole of dodecanoic acid, and 1 g of sodium hydroxide were charged into a stirring-tank type reactor, and heated at 200° C. for 4 hours under a nitrogen stream. Into 100 g of this reaction product material, 200 mL of n-butyl alcohol was added, and the resultant mixture was heated to 70° C. and dissolved, then into which 100 mL of 1% sodium sulfate aqueous solution that had been heated to 70° C. was added and mixed. The resultant mixture was left to stand for 5 minutes, then the lower layer is separated and removed. The upper layer was dried under reduced pressure, and thus a glycerol fatty acid ester in a solid state was obtained.

Exemplary compound 2: the exemplary compound 2 was obtained in the same manner as that of exemplary compound 1 except that the dodecanoic acid in the exemplary compound 1 was changed to montanic acid.

Exemplary compound 3: the exemplary compound 3 was obtained in the same manner as that of exemplary compound 1 except that the dodecanoic acid in the exemplary compound 1 was changed to behenic acid.

Exemplary compound 4: the exemplary compound 4 was obtained in the same manner as that of exemplary compound 1 except that the dodecanoic acid in the exemplary compound 1 was changed to stearic acid, and the glycerol was changed to pentaerythritol.

Exemplary compound 5: the exemplary compound 5 was obtained in the same manner as that of exemplary compound 4 except that the stearic acid in the exemplary compound 4 was changed to 2-methyl-stearic acid.

Exemplary compound 6: the exemplary compound 6 was obtained in the same manner as that of exemplary compound 4 except that the 1 mole of stearic acid in the exemplary compound 4 was changed to 2 moles of heptanoic acid.

Exemplary compound 7: the exemplary compound 7 was obtained in the same manner as that of exemplary compound 6 except that the heptanoic acid in the exemplary compound 6 was changed to hexadecanoic acid.

Exemplary compound 8: the exemplary compound 8 was obtained in the same manner as that of exemplary compound 6 except that the 2 moles of heptanoic acid in the exemplary compound 6 was changed to 1 mole of erucic acid and 1 mole of formic acid.

Comparative compound 1: the comparative compound 1 was obtained in the same manner as that of exemplary compound 1 except that the dodecanoic acid in the exemplary compound 1 was changed to heptanoic acid.

Comparative compound 2: the comparative compound 2 was obtained in the same manner as that of exemplary compound 1 except that the dodecanoic acid in the exemplary compound 1 was changed to hexatetracontaneoic acid.

Comparative compound 3: the comparative compound 3 was obtained in the same manner as that of exemplary compound 4 except that the dodecanoic acid in the exemplary compound 4 was changed to heptanoic acid.

Comparative compound 4: the comparative compound 4 was obtained in the same manner as that of exemplary compound 4 except that the dodecanoic acid in the exemplary compound 4 was changed to hexatetracontaneoic acid.

Comparative compound 5: the comparative compound 5 was obtained in the same manner as that of exemplary compound 4 except that the 1 mole of dodecanoic acid in the exemplary compound 4 was changed to 2 moles of pentanoic acid.

Comparative compound 6: the comparative compound 6 was obtained in the same manner as that of exemplary compound 5 except that the 2 moles of pentanoic acid in the exemplary compound 5 was changed to 1 mole of erucic acid and 1 mole of 3-methyl-tricosanoic acid.

Comparative compound 7: pentaerythritol tetrastearate (PETS) (EXCEPARL PE-MS manufactured by Kao Corporation) was used.

Comparative compound 8: stearic acid amide (Fatty Acid Amide S manufactured by Kao Corporation) was used.

### Example 1

90 parts by mass of polycarbonate resin and 10 parts by mass of polyester resin were dry blended by using a V-type mixer, and the resultant blend was dried at 100° C. for 4 hours under reduced pressure by using a vacuum dryer. 100 parts by mass of the dried mixture, and the lubricant shown in the following Table 1 (exemplary compound 1) in the predetermined parts by mass shown in Table 1 were dry blended by using a V-type mixer. The resultant mixture was charged from a raw material supply port of a twin-screw kneading extruder (manufactured by Kobe Steel, Ltd.), and melt-kneaded under the conditions of a discharge rate of 10 kg/hr and a resin pressure of 4 MPa. The kneaded mixture discharged from the twin-screw kneading extruder was rapidly cooled by the immersion into water at 30° C., then pulverized into pellets by using a pelletizer, and thus a resin composition was obtained.

### Examples 2 to 9, and Comparative Examples 1 to 9

The resin composition was obtained in the same manner as in Example 1 except that the lubricant was changed to a lubricant shown in the following Table 1.

As to a resin composition obtained in each of the Examples and Comparative examples, the following evaluations were performed. The results were shown in the following Table 2.

### (1) Flowability

After the resin composition was dried at 100° C. for 4 hours, the flow length was evaluated for a bar flow test piece (flow channel thickness: 1 mm, and flow channel width: 8 mm) by using an injection molding machine “J55ELII” (manufactured by The Japan Steel Works, Ltd.) according to the following evaluation criteria. The conditions were set to a cylinder temperature of 280° C., a mold temperature of 40° C., and an injection pressure of 40 MPa. The longer the flow length is, the better the flowability is.
⊙: 100 mm or more
◯: 60 mm or more but less than 100 mm
Δ: 20 mm or more but less than 60 mm (there is no practical problem)

X: Less than 20 mm (there is a practical problem)

### (2) Evaluation of a Burning/Silver Molding Defect

After the resin composition was dried at 100° C. for 4 hours, by using an injection molding machine “J55ELII” (manufactured by The Japan Steel Works, Ltd.), a strip type test piece with width 200 mm×length 200 mm×thickness 4 mm was molded at a cylinder set temperature of 280° C., a mold temperature of 40° C., and an injection pressure of 40 MPa. Evaluation was performed as follows: after 300 shots were discarded, consecutive 100 shots were molded, and the number of the molded articles in which burning or silver had been observed was measured.
◯: 0 to 4 pieces
X: 5 or more pieces

### (3) Charpy Impact Strength

After the resin composition was dried at 100° C. for 4 hours, by using an injection molding machine “J55ELII” (manufactured by The Japan Steel Works, Ltd.), a strip type test piece with 100 mm×10 mm×4 mm was molded at a cylinder set temperature of 280° C., and a mold temperature of 40° C. Charpy impact test (U-notch, and R=1 mm) was performed in accordance with “JIS-K7111”, and the Charpy impact strength was evaluated according to the following evaluation criteria.
⊙: 42 kJ/m² or more
◯: 32 kJ/m² or more but less than 42 kJ/m²
Δ: 6 kJ/m² or more but less than 32 kJ/m² (there is no practical problem)
X: Less than 6 kJ/m² (there is a practical problem)

TABLE 1

| | General | | |
|---|---|---|---|
| Compound | Formula | R1 | R2 |
| Exemplary compound 1 | (1) | 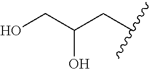 [SMILES: *CC(O)CO] | 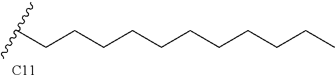 [SMILES: *CCCCCCCCCCC ; "C11"] |
| Exemplary compound 2 | (1) | 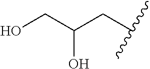 [SMILES: *CC(O)CO] | 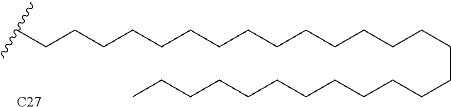 [SMILES: *CCCCCCCCCCCCCCCCCCCCCCCCCCC ; "C27"] |
| Exemplary compound 3 | (1) | 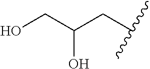 [SMILES: *CC(O)CO] | 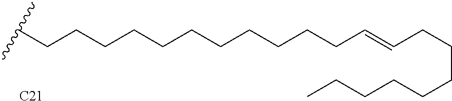 [SMILES: "C21" ; *CCCCCCCCCCC/C=C/CCCCCCCC] |
| Exemplary compound 4 | (1) | 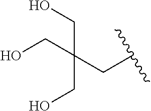 [SMILES: *CC(CO)(CO)CO] | 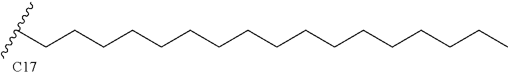 [SMILES: *CCCCCCCCCCCCCCCCC ; "C17"] |
| Exemplary compound 5 | (1) | 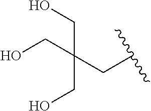 [SMILES: *CC(CO)(CO)CO] | 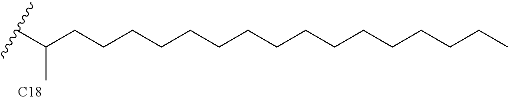 [SMILES: *C(C)CCCCCCCCCCCCCCCC ; "C18"] |
| Comparative compound 1 | (1) | 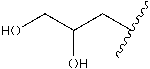 [SMILES: *CC(O)CO] | 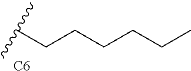 [SMILES: *CCCCCC ; "C6"] |
| Comparative compound 2 | (1) | 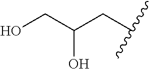 [SMILES: *CC(O)CO] | 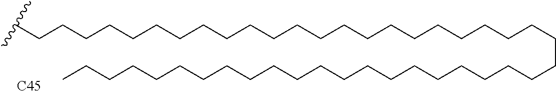 [SMILES: *CCCCCCCCCCCCCCCCCCCCCCCCCCCCCCCCCCCCCCCCCCCCC ; "C45"] |
| Comparative compound 3 | (1) | 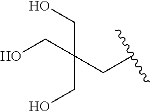 [SMILES: *CC(CO)(CO)CO] | 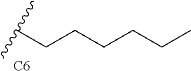 [SMILES: *CCCCCC ; "C6"] |
| Comparative compound 4 | (1) | 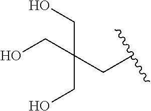 [SMILES: *CC(CO)(CO)CO] | 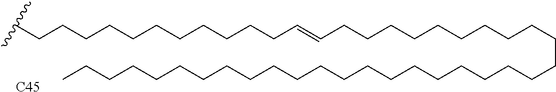 [SMILES: *CCCCCCCCCCC/C=C/CCCCCCCCCCCCCCCCCCCCCCCCCCCCCCCC ; "C45"] |

| Compound | Molecular structure |
|---|---|
| Exemplary compound 1 | 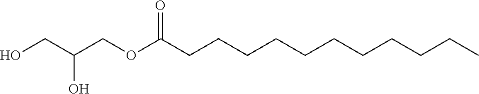 [SMILES: CCCCCCCCCCCC(=O)OCC(O)CO] |
| Exemplary compound 2 | 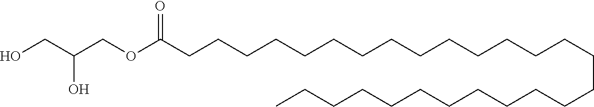 [SMILES: CCCCCCCCCCCCCCCCCCCCCCCCCCCC(=O)OCC(O)CO] |
| Exemplary compound 3 | 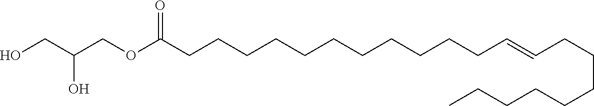 [SMILES: CCCCCCCC/C=C/CCCCCCCCCCCC(=O)OCC(O)CO] |
| Exemplary compound 4 | 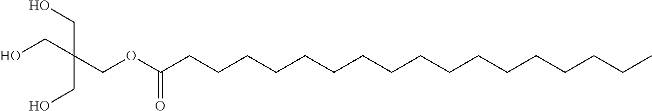 [SMILES: CCCCCCCCCCCCCCCCCC(=O)OCC(CO)(CO)CO] |
| Exemplary compound 5 | 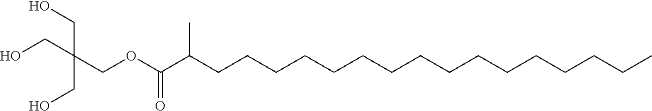 [SMILES: CCCCCCCCCCCCCCCCC(C)C(=O)OCC(CO)(CO)CO] |
| Comparativecompound 1 | 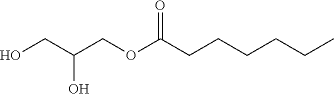 |
| Comparativecompound 2 | 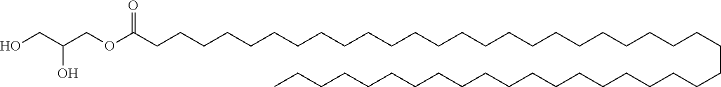 [SMILES: CCCCCCCCCCCCCCCCCCCCCCCCCCCCCCCCCCCCCCCCCCCCCC(=O)OCC(O)CO] |
| Comparativecompound 3 | 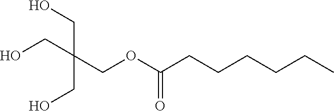 [SMILES: CCCCCCC(=O)OCC(CO)(CO)CO] |
| Comparativecompound 4 | 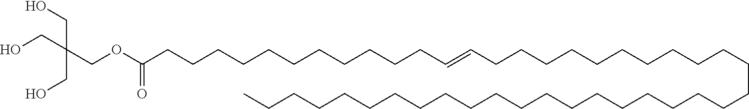 [SMILES: CCCCCCCCCCCCCCCCCCCCCCCCCCCCCCCC/C=C/CCCCCCCCCCCC(=O)OCC(CO)(CO)CO] |

| | General | | |
|---|---|---|---|
| Compound | Formula | R3 | R4 |
| Exemplary compound 6 | (2) | 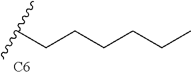 [SMILES: *CCCCCC ; "C6"] | 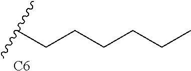 [SMILES: *CCCCCC ; "C6"] |
| Exemplary compound 7 | (2) | 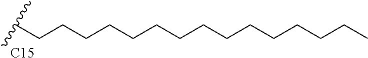 [SMILES: *CCCCCCCCCCCCCCC ; "C15"] | 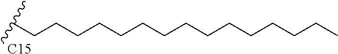 [SMILES: *CCCCCCCCCCCCCCC ; "C15"] |
| Exemplary compound 8 | (2) | 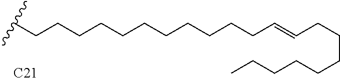 [SMILES: "C21" ; *CCCCCCCCCCC/C=C/CCCCCCCC] | 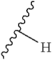 [SMILES: *[H]] |
| Comparative compound 5 | (2) | 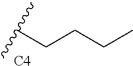 [SMILES: *CCCC ; "C4"] | 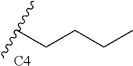 [SMILES: *CCCC ; "C4"] |
| Comparative compound 6 | (2) | 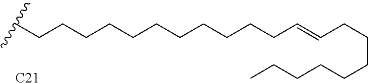 [SMILES: "C21" ; *CCCCCCCCCCC/C=C/CCCCCCCC] | 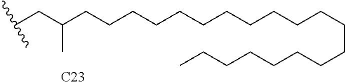 [SMILES: *CC(C)CCCCCCCCCCCCCCCCCCCC ; "C23"] |

| Compound | Molecular structure |
|---|---|
| Exemplary compound 6 | 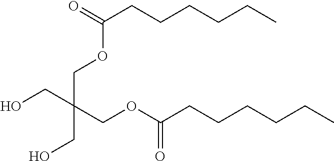 [SMILES: CCCCCCC(=O)OCC(CO)(CO)COC(=O)CCCCCC] |
| Exemplary compound 7 | 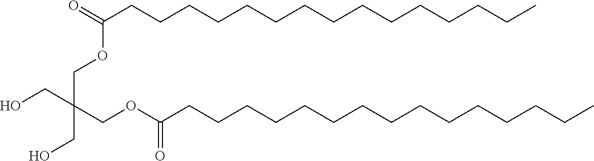 [SMILES: CCCCCCCCCCCCCCCC(=O)OCC(CO)(CO)COC(=O)CCCCCCCCCCCCCCC] |
| Exemplary compound 8 | 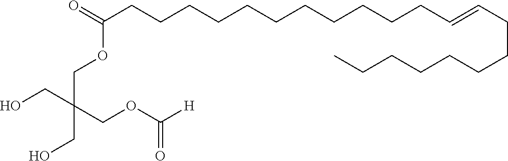 [SMILES: CCCCCCCC/C=C/CCCCCCCCCCCC(=O)OCC(CO)(CO)COC=O] |
| Comparative compound 5 | 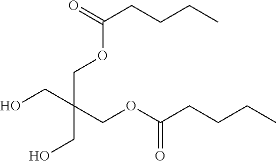 [SMILES: CCCCC(=O)OCC(CO)(CO)COC(=O)CCCC] |
| Comparative compound 6 | 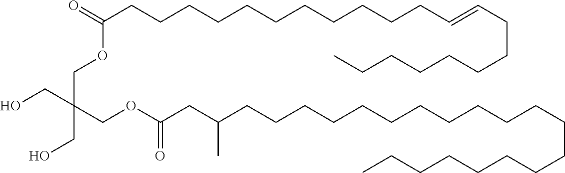 [SMILES: CCCCCCCC/C=C/CCCCCCCCCCCC(=O)OCC(CO)(CO)COC(=O)CC(C)CCCCCCCCCCCCCCCCCCCC] |

TABLE 2

| | | | The number of | | | | | | |
|---|---|---|---|---|---|---|---|---|---|
| | | Chemical | carbon atoms | | | Addition amount | | Burning | Impact |
| | Compound | formula | R2 | R3 | R4 | (parts by mass) | Flowability | and Silver | strength |
| Example 1 | Exemplary | (1) | 11 | — | — | 0.05 | ⊙ | ◯ | ⊙ |
| | compound 1 | | | | | | | | |
| Example 2 | Exemplary | (1) | 27 | — | — | 0.05 | ◯ | ◯ | ⊙ |
| | compound 2 | | | | | | | | |
| Example 3 | Exemplary | (1) | 21 | — | — | 0.05 | ⊙ | ◯ | ⊙ |
| | compound 3 | | | | | | | | |
| Example 4 | Exemplary | (1) | 17 | — | — | 0.05 | ⊙ | ◯ | ⊙ |
| | compound 4 | | | | | | | | |
| Example 5 | Exemplary | (1) | 18 | — | — | 0.05 | ⊙ | ◯ | ⊙ |
| | compound 5 | | | | | | | | |
| Example 6 | Exemplary | (2) | — | 6 | 6 | 4 | ⊙ | ◯ | ◯ |
| | compound 6 | | | | | | | | |
| Example 7 | Exemplary | (2) | — | 15 | 15 | 0.02 | ◯ | ◯ | ⊙ |
| | compound 7 | | | | | | | | |
| Example 8 | Exemplary | (2) | — | 21 | 0 | 0.02 | ◯ | ◯ | ⊙ |
| | compound 8 | | | | | | | | |
| Example 9 | Exemplary | (1) | 27 | — | — | 8 | ⊙ | ◯ | ◯ |
| | compound 2 | | | | | | | | |
| Comparative | None | — | — | — | — | 0 | X | X | ⊙ |
| example 1 | | | | | | | | | |
| Comparative | Comparative | (1) | 6 | — | — | 0.05 | ◯ | X | X |
| example 2 | example 1 | | | | | | | | |
| Comparative | Comparative | (1) | 45 | — | — | 0.05 | X | ◯ | ◯ |
| example 3 | example 2 | | | | | | | | |
| Comparative | Comparative | (1) | 6 | — | — | 0.05 | Δ | ◯ | X |
| example 4 | example 3 | | | | | | | | |
| Comparative | Comparative | (1) | 45 | — | — | 0.05 | X | ◯ | Δ |
| example 5 | example 4 | | | | | | | | |
| Comparative | Comparative | (2) | — | 4 | 4 | 0.05 | ◯ | X | X |
| example 6 | example 5 | | | | | | | | |
| Comparative | Comparative | (2) | — | 21 | 23 | 0.50 | X | X | ◯ |
| example 7 | example 6 | | | | | | | | |
| Comparative | Comparative | — | — | — | — | 0.05 | X | ◯ | ◯ |
| example 8 | example 7 | | | | | | | | |
| | (PETS) | | | | | | | | |
| Comparative | Comparative | — | — | — | — | 0.05 | ◯ | ◯ | X |
| example 9 | compound 8 | | | | | | | | |
| | (stearic acid amide) | | | | | | | | |

As shown in the above Table 2, in a resin composition of Examples 1 to 9 in which a specific lubricant represented by the General Formula (1) or (2) had been used, the flowability was high, and the generation of burning or silver was hardly observed in the molded article. This is considered that the lubricant represented by the General Formula (1) or (2) is easily settled to a resin, and is homogeneously dispersed in the resin. In particular, in Examples 1 to 8 in which the content of the lubricant had been set to 0.01 to 5 parts by mass relative to 100 parts by mass of resin, a molded article having high impact strength was obtained.

On the other hand, in Comparative example 1 in which a lubricant was not used, and in Comparative examples 2 to 9 in which a lubricant having a structure different from the General Formula (1) or (2) was used, the flowability was insufficient.

1. A thermoplastic resin composition comprising at least a polycarbonate resin, a polyester resin, and a lubricant,
wherein the lubricant contains a compound represented by the following General Formula (1) or (2). 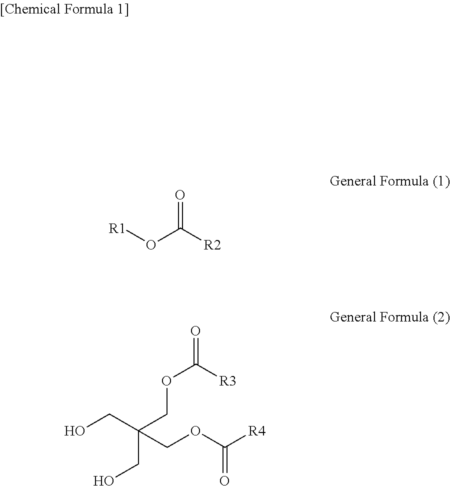
(In the General Formula (1), R1 has a structure represented by the following Chemical formula, 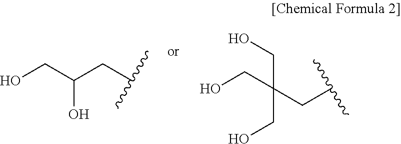
and R2 is substituted or unsubstituted alkyl group, alkenyl group, alkynyl group, cycloalkyl group, cycloalkenyl group, or cycloalkynyl group that has 11 to 40 carbon atoms, and
in the General Formula (2), each of R3 and R4 is independently a hydrogen atom, or substituted or unsubstituted alkyl group, alkenyl group, alkynyl group, cycloalkyl group, cycloalkenyl group, or cycloalkynyl group that has 1 to 40 carbon atoms, provided that a sum of the number of the carbon atoms of R3 and R4 is 11 to 40.)

2. The thermoplastic resin composition according to claim 1, wherein the lubricant is contained in an amount of 0.01 to 5 parts by mass relative to 100 parts by mass of a total mass of the polycarbonate resin and the polyester resin.

3. The thermoplastic resin composition according to claim 1, wherein the polycarbonate resin is mixed with the polyester resin at a mixing ratio of 70 to 2 parts by mass of the polyester resin relative to 30 to 98 parts by mass of the polycarbonate resin.

4. The thermoplastic resin composition according to claim 1, wherein a content of the compound represented by the General Formula (1) or (2) in the lubricant is at least 80% by mass or more.

5. The thermoplastic resin composition according to claim 1, wherein the number of the carbon atoms of R2 in the General Formula (1) is in the range of 13 to 35.

6. The thermoplastic resin composition according to claim 1, wherein the sum of the number of the carbon atoms of R3 and R4 in the General Formula (2) is in the range of 13 to 35.

7. The thermoplastic resin composition according to claim 1, wherein one or more kinds of resin materials selected from polyolefins, polyamides, elastomers, and ABS resins are contained in an amount of 0.1 to 20% by mass relative to 100% by mass of a total mass of the polycarbonate resin and the polyester resin.

8. The thermoplastic resin composition according to claim 1, wherein one or more kinds of additives selected from a crosslinking agent, an antioxidant, a thermal stabilizer, a transesterification inhibitor, an ultraviolet absorbing agent, a light stabilizer, a pigment, a dye, a flame retardant, an antistatic agent, a foaming agent, a drip preventing agent, and a filler are contained in an amount of 0.01 to 10% by mass relative to 100% by mass of a total mass of the polycarbonate resin and the polyester resin.
